(19) United States
(12) Patent Application Publication
(10) Pub. No.: US 2006/0047731 A1
(43) Pub. Date: Mar. 2, 2006

(54) Document-management device, document-management program, recording medium, and document-management method

(76) Inventor: Yoshiro Matsui, Saitama (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/212,691

(22) Filed: Aug. 29, 2005

(30) Foreign Application Priority Data
Sep. 1, 2004 (JP) 2004-254571
Aug. 2, 2005 (JP) 2005-224697

(51) Int. Cl. G06F 17/30

(52) U.S. Cl. 707/205

(57) ABSTRACT

In a document management device, a document-management unit manages documents, and an access control management unit manages information of a taking-over relation between groups of an access right of a document. The document-management unit acquires, in response to a document acquisition request from a client, both information of a currently valid group to which a user who has sent the document acquisition request belongs and information of a past group from which the currently valid group takes over an access right of the document, from the access control management unit. And the document-management unit determines whether information of group IDs of groups allowed to access the document is contained in the acquired information of the currently valid group and the past group.

### BACKGROUND OF THE INVENTION

1. Field of the Invention

The present invention relates to a document-management device, a document-management program, a recording medium and a document-management method which are capable of efficiently taking measures to changes of the organization.

2. Description of the Related Art

Generally, the ACL (access control list) is given to documents in the document management system in a company, and the access right to the organization is managed for every document.

However, changes of the organization sometimes occur in the company, and the document management system has the problem that the ACL given to the document must be changed for every time of change of the organization.

In the document management system, the processing of changing the ACL for every document becomes a heavy load when the number of the documents increases. In many cases, several days have passed until the ACL of all the documents is changed after the actual change of the organization is effected. There is a time lag between the change of the organization and the change of the ACL.

The conventional technology related to the document management is disclosed in, for example, Japanese Laid-Open Patent Applications No. 07-319921 and No. 2003-280990.

In the system disclosed in Japanese Laid-Open Patent Applications No. 07-319921, the batch processing to change the information is carried out by the document management system, and there is the problem that when the number of documents being processed increases the load of the processing becomes heavy.

The system disclosed in Japanese Laid-Open Patent Applications No. 2003-280990 is able to take measures to personnel reassignment. However, there is the problem that the system cannot be coped with large-scale changes of the organization.

### SUMMARY OF THE INVENTION

An object of the present invention is to provide an improved document-management device in which the above-described problems are eliminated.

Another object of the present invention is to provide a document-management device, a document-management program, a recording medium and a document-management method which are capable of efficiently taking measures to changes of the organization.

In order to achieve the above-mentioned objects, the present invention provides a document-management device comprising: a document-management unit managing documents; and an access control management unit managing information of a taking-over relation between groups of an access right of a document, wherein the document-management unit acquires, in response to a document acquisition request from a client, both information of a currently valid group to which a user who has sent the document acquisition request belongs and information of a past group from which the currently valid group takes over an access right of the document, from the access control management unit, and the document-management unit determines whether information of group IDs of groups allowed to access the document is contained in the acquired information of the currently valid group and the past group.

According to the above-mentioned document-management device, it is possible to efficiently take measures to changes of the organization.

In order to achieve the above-mentioned objects, the present invention provides a computer program product embodied therein for causing a computer to execute a document-management method, the computer acting as a document-management device including a document-management unit managing documents, and an access control management unit managing information of a taking-over relation between groups of an access right of a document, the document-management method comprising: acquiring, in response to a document acquisition request from a client, both information of a currently valid group to which a user who has sent the document acquisition request belongs and information of a past group from which the currently valid group takes over an access right of the document, from the access control management unit; and determining whether information of group IDs of groups allowed to access the document is contained in the acquired information of the currently valid group and the past group.

In order to achieve the above-mentioned objects, the present invention provides a computer-readable recording medium embodied therein for causing a computer to execute a document-management method, the computer acting as a document-management device including a document-management unit managing documents, and an access control management unit managing information of a taking-over relation between groups of an access right of a document, the document-management method comprising: acquiring, in response to a document acquisition request from a client, both information of a currently valid group to which a user who has sent the document acquisition request belongs and information of a past group from which the currently valid group takes over an access right of the document, from the access control management unit; and determining whether information of group IDs of groups allowed to access the document is contained in the acquired information of the currently valid group and the past group.

In order to achieve the above-mentioned objects, the present invention provides a document-management method for use in a document-management device including a document-management unit managing documents, and an access control management unit managing information of a taking-over relation between groups of an access right of a document, the document-management method comprising: acquiring, in response to a document acquisition request from a client, both information of a currently valid group to which a user who has sent the document acquisition request belongs and information of a past group from which the currently valid group takes over an access right of the document, from the access control management unit; and determining whether information of group IDs of groups allowed to access the document is contained in the acquired information of the currently valid group and the past group.

According to the present invention, the document-management device, the document-management program, the recording medium, and the document-management method can efficiently take measures to changes of the organization.

### BRIEF DESCRIPTION OF THE DRAWINGS

Other objects, features and advantages of the present invention will be apparent from the following detailed description when reading in conjunction with the accompanying drawings.

FIG. 1 is a diagram showing the hardware composition of an embodiment of the document-management device.

FIG. 2 is a diagram showing the composition of an embodiment of the document management system.

FIG. 3 is a diagram showing the composition of an embodiment of the document management system.

FIG. 4 is a sequence diagram for explaining the document acquisition processing.

FIG. 5 is a diagram showing an example of the user/group management database.

FIG. 6 is a diagram showing an example of the access control management database.

FIG. 7 is a diagram showing an example of changes of a group.

FIG. 8 is a diagram showing the composition of an embodiment of the document management system when the MFP is used as the document-management device.

FIG. 9 is a sequence diagram for explaining the processing performed at the time of change of the organization.

FIG. 10 is a diagram showing a user/group management model.

FIG. 11 is a sequence diagram for explaining the processing performed at the time of change of the organization.

FIG. 12 is a diagram showing a user/group management model.

### DETAILED DESCRIPTION OF PREFERRED EMBODIMENTS

A description will now be given of an embodiment of the invention with reference to the accompanying drawings.

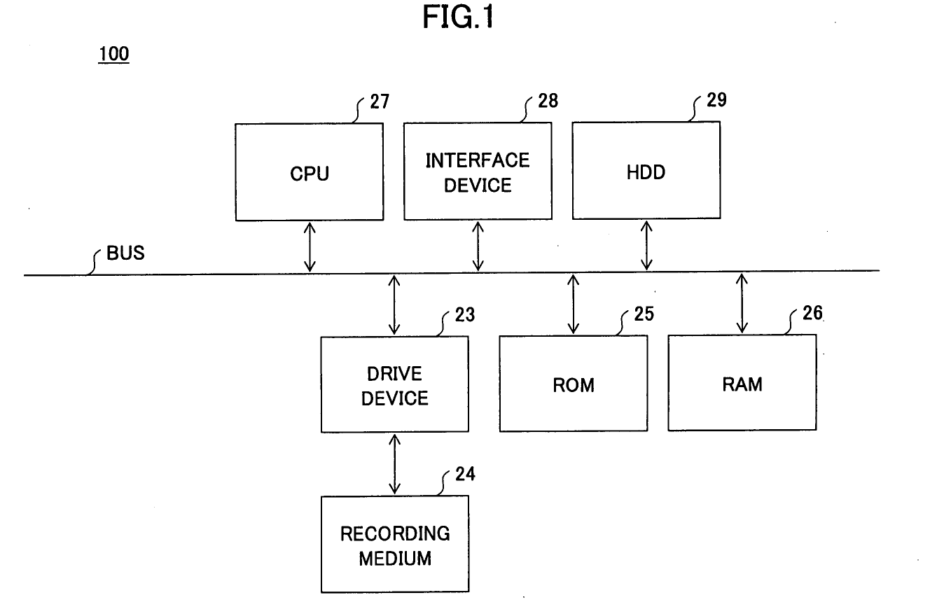

FIG. 1 shows the hardware composition of the embodiment of the document-management device 100 which is capable of efficiently taking measures to changes of the organization.

The document-management device 100 shown in FIG. 1 comprises the drive device 23, the ROM (read only memory) 25, the RAM (random access memory) 26, the CPU (central processing unit) 27, the interface device 28, and the HDD (hard disk drive) 29, which are interconnected by the bus.

The interface device 28 provides an interface which is used to connect the document-management device 100 with a network.

The program (called a document-management program) corresponding to each of the functions of the document-management device 100 (which will be described later) is loaded onto the document-management device 100 by using the recording medium 24, such as CD-ROM, or it is downloaded through the network.

The recording medium 24 is placed in the drive device 23, and the document-management program from the recording medium 24 is installed into the HDD 29 through the drive device 23. The ROM 25 stores data or the like.

The RAM 26 reads and stores the document-management program from the HDD 29 at the time of start up of the document-management device 100. The RAM 26 holds temporarily the data used for the processing of the document-management program.

The CPU 21 performs the processing according to the document-management program stored in the RAM 26.

The HDD 29 stores the document-management program and data (for example, data stored in a database).

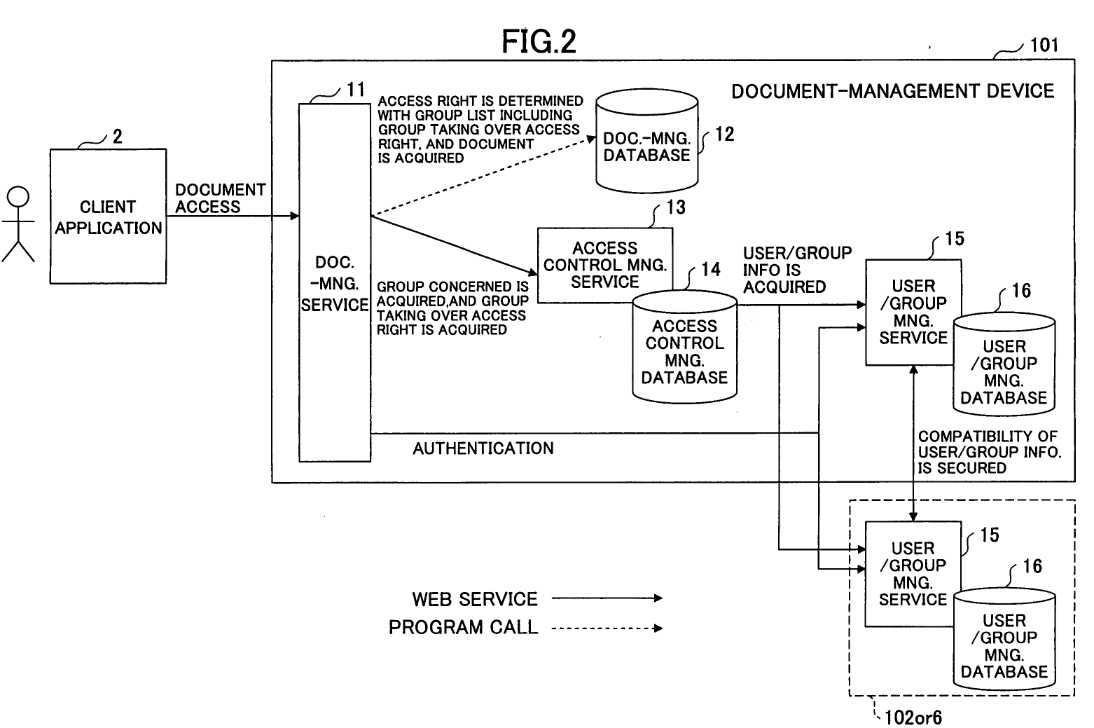

FIG. 2 shows the composition of an embodiment of the document management system which is capable of efficiently taking measures to changes of the organization.

As shown in FIG. 2, the document management system comprises the client application 2 which is installed in the personal computer (PC), the document-management device 101, and the user management device 6 having the user/group management service 15, and the user/group management database 16, or the document-management device 102 having the same functional composition as that of the document-management device 101.

The document-management device 100 (101, 102) comprises the document-management service 11, the document-management database 12, the access control management service 13, the access control management database 14, the user/group management service 15, and the user/group management database 16.

The document-management service 11 is the service which manages documents. For example, when an authentication request is received from the client application 2, the document-management service 11 performs the authentication using the user/group management service 15. When an access request of a document is received from the client application 2, the document-management service 11 determines whether a valid access right of the document exists for the user who requested the document access. When it is determined that the valid access right exists, the document-management service 11 provides the user (or the client application 2) with the document.

The document-management database 12 manages and stores the documents by associating each document with ACL (access control list or access right) related to the document.

The access control management service 13 is the service which manages the taking-over relation of the access right of each document.

For example, the acquisition request of the information of a currently valid group is transmitted to the document applied to an access request to a user/group management service 15 in accordance with the request from document-management service 11.

While acquiring the information on the group, the take-over information of the group which takes over the access right of the document stored in access control management database 14 is referred to.

The information on the past group which received taking over of the access right is generated, and the acquired group valid now merges the information on the generated group, and the acquired information of a currently valid group, and provides for the request origin of document-management service 11.

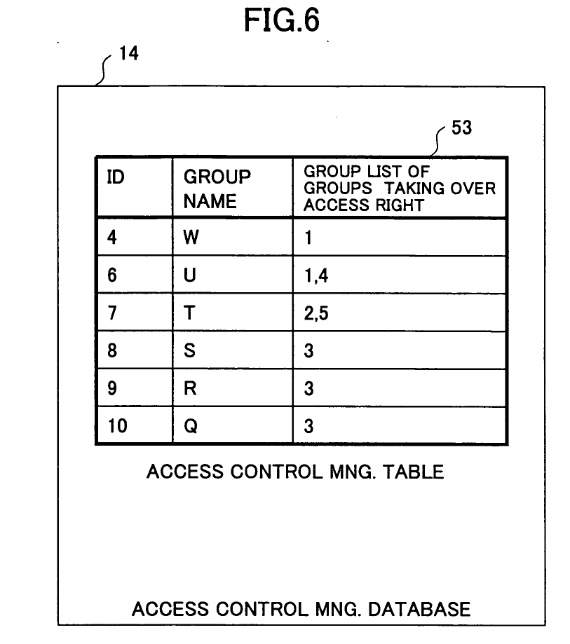

The access control management database 14 manages and stores the take-over information of the access right of every document. An example of the table contained in the access control management database 14 is shown in FIG. 6.

The user/group management service 15 is the service which manages the account information. For example, in accordance with the request from the document-management service 11, a user authentication is carried out by the user/group management service 15. Or in accordance with the request from the access control management service 13, the information of a currently valid group is acquired from the user/group management database 16 by the user/group management service 15.

As shown in FIG. 2, the user/group management service 15 may be distributed on a network. The access control management service 13 collects and manages the user information and the group information which are managed by the user/group management service 15 distributed on the network.

However, the compatibility of the user information and the group information between the user/group management service 15 at one node of the network and the user/group management service 15 at another node of the network must be secured.

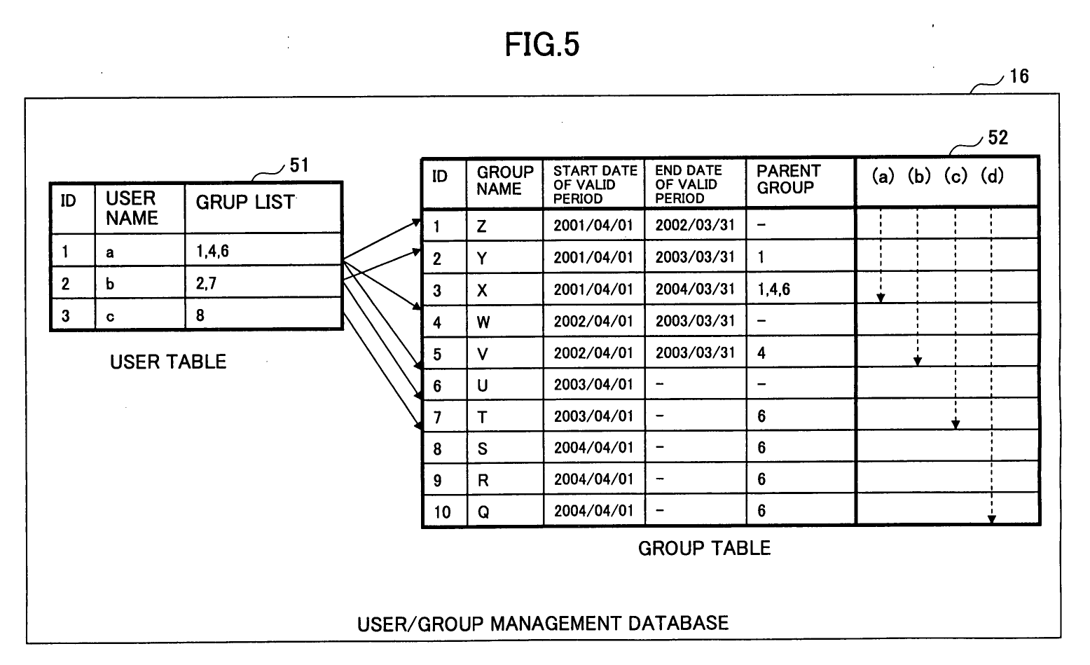

The user/group management database 16 manages and stores the user information and the group information of the group to which the user belongs. An example of the table contained in the user/group management database 16 is shown in FIG. 5.

In FIG. 2 and the subsequent figures, the solid line indicates a communication (calling) between the Web services using the SOAP, and the dotted line indicates a normal program call.

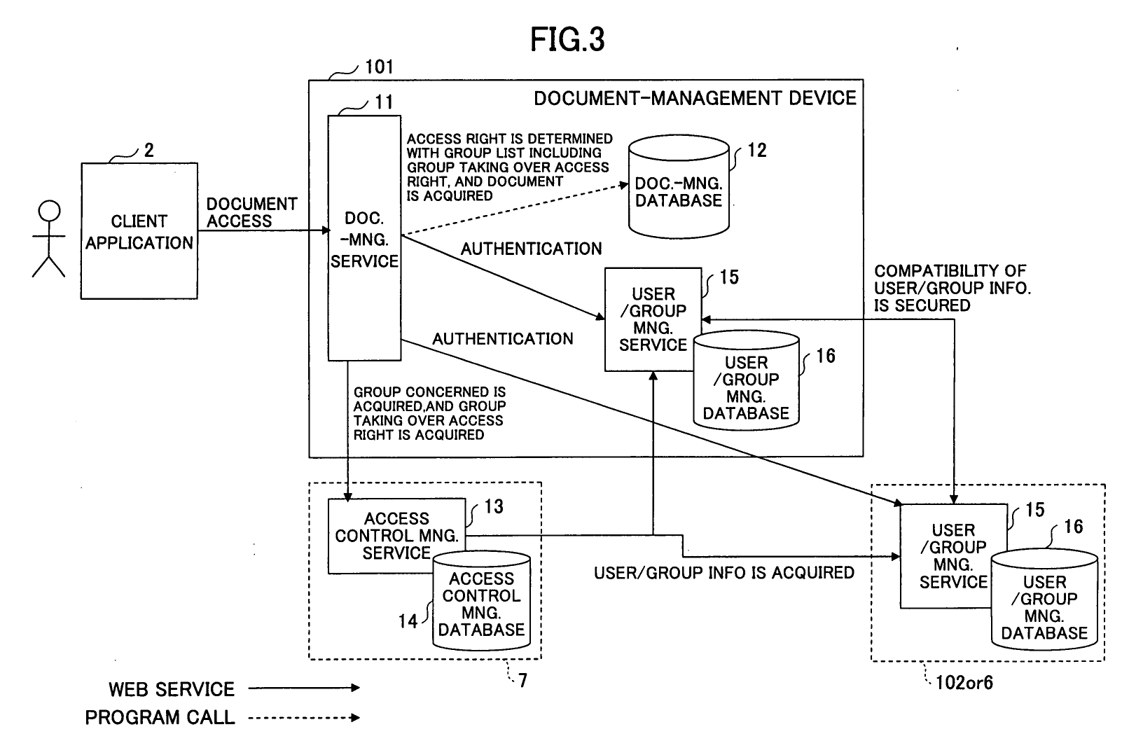

FIG. 3 shows the composition of an embodiment of the document management system which is capable of efficiently taking measures at the time of change of the organization.

Compared with the composition of the document management system shown in FIG. 2, the composition of the document management system shown in FIG. 3 includes the access control management service 13 and the access control management database 14 which are contained in the external device 7 other than the document-management device 101.

In FIG. 3, the access control management service 13 and the access control management database 14 are illustrated as what are contained in the document-management device 100 shown in FIG. 1, and the access control controlling device 7 which has the same hardware composition.

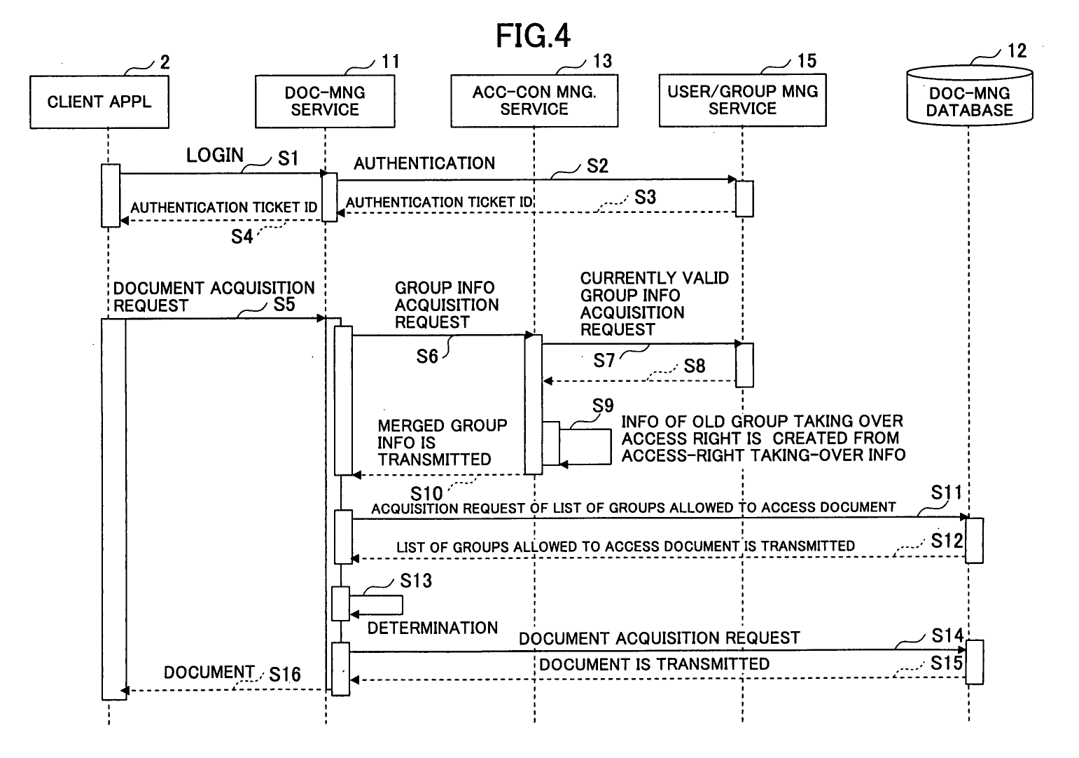

In the following, the document management system will be described as having the composition shown in FIG. 2 for simplification of explanation. Hereafter, an example of the document acquisition processing is shown in FIG. 4.

FIG. 4 is a sequence diagram for explaining the document acquisition processing.

The client application 2 transmits a login request, including the authentication information of the user ID and password entered by the user, to the document-management service 11 (step S1).

When the login request is received from the client application 2, the document-management service 11 creates an authentication request including the authentication information included in the login request, and transmits the same to the user/group management service 15 (step S2).

The user/group management service 15 performs authentication based on the authentication information included in the authentication request received. If the authentication is completed successfully, the user/group management service 15 creates an authentication ticket, and transmits the authentication ticket ID which identifies the authentication ticket to the document-management service 11 (step S3).

The document-management service 11 transmits the authentication ticket ID to the client application 2 when the authentication ticket ID is received from the user/group management service 15 (step S4).

When the authentication ticket ID is received from the document-management service 11, the client application 2 transmits a document acquisition request, containing the authentication ticket ID and the document ID which identifies the document whose acquisition is requested, to the document-management service 11 (step S5).

When the acquisition request of the document is received from the client application 2, the document-management service 11 creates an acquisition request of the information of the corresponding user's belonging group containing the authentication ticket ID contained in the document acquisition request, and transmits the same to the access control management service 13 (step S6).

When the acquisition request of the information of the belonging group of the corresponding user is received from the document-management service 11, the access control management service 13 transmits the acquisition request of the information of the currently valid group to which the corresponding user belongs, containing the authentication ticket ID contained in the belonging group's information acquisition request, to the user/group management service 15 (step S7).

When the acquisition request of the information of the currently valid is received from the access control management service 13, the user/group management service 15 makes reference to the user table 51 and the group table 52 of the user/group management database 16, acquires the information of the currently valid group based on the term of validity (the start date and the end date), and transmits the same to the access control management service 13 (step S8).

For example, when the user is the user name “b”, the user/group management service 15 makes reference to the user table 51 and the group table 52, acquires as the information of the currently valid group the ID “7” which identifies group T, and transmits it to the access control management service 13.

The user/group management service 15 specifies the authentication ticket from the authentication ticket ID, and specifies the user from the authentication ticket.

When the information of the currently valid group is acquired from the user/group management service 15, the access control management service 13 makes reference to the access control management table 53, and creates (or acquires) the information of the past group from which the currently valid group takes over the access right (step S9).

The information of the past group and the information of the currently valid group are merged, and the access control management service 13 transmits the merged information to the document-management service 11 as the belonging group's information (step S10).

For example, the access control management service 13 acquires the ID “7” which identifies group T from the user/group management service 15, makes reference to the access control management table 53, and acquires, as the information of the past group from which the currently valid group takes over the access right, the ID “2” which identifies group Y and the ID “5” which identifies group V. The ID “2” and the ID “5” acquired from the access control management table 53, and the ID “7” acquired from the user/group management service 15 are merged, and the access control management service 13 transmits the group ID “2”, the group ID “5”, and the group ID “7” of the merged information to the document-management service 11.

The document-management service 11 creates an acquisition request of the group list information of the groups (which are allowed to access the document) containing the authentication ticket ID and the document ID, and transmits the same to the document-management database 12 (step S11). The document-management service 11 receives the group list information of the groups (which are allowed to access the document identified by the document ID) from the document-management database 12 (step S12).

The document-management service 11 acquires the group list information of the groups (which are allowed to access the document) based on the documents and the ACL of each document stored and managed in the document-management database 12.

For example, the document-management service 11 acquires the group ID “5” and the group ID “6” from the document-management database 12 as the group list information of the groups (which are allowed to access the document identified by the document ID).

The document-management service 11 determines whether a part of the group IDs of the merged information received in step S10 is contained in the group list information of the groups received (or acquired) in step S12 (step S13).

When it is determined that the part of the group IDs of the merged information received in step S10 is contained in the group list information of the groups received in step S12, the document-management service 11 creates a document acquisition request containing the authentication ticket ID and the document ID, and transmits the same to the document-management database 12 (step S14). And the document-management service 11 acquires the document corresponding to the document ID from the document-management database 12 (step S15).

For example, suppose that the document-management service 11 in step S10 acquires the group ID “2”, the group ID “5”, and the group ID “7”, and in step S12 acquires the group ID “5” and the group ID “6”. In such a case, the document-management service 11 determines that the part of the group IDs of the merged information received in step S10 is contained in the group list information of the groups acquired in step S12.

When the document is acquired (or received) from the document-management database 12, the document-management service 11 transmits the acquired document to the client application 2 of the requesting node (step S16).

By performing the processing shown in FIG. 4, the document-management device of this embodiment can efficiently take measures at the time of change of the organization when providing the service related to the management of documents.

Next, FIG. 5 shows an example of the user/group management database 16.

As shown in FIG. 5, the user/group management database 16 comprises the user table 51 and the group table 52. Each of records in the user table 51 contains the ID, the user name, and the group list, and each of records in the group table 52 contains the ID, the group name, the start date of the term of validity, the end date of the term of validity, and the parent group.

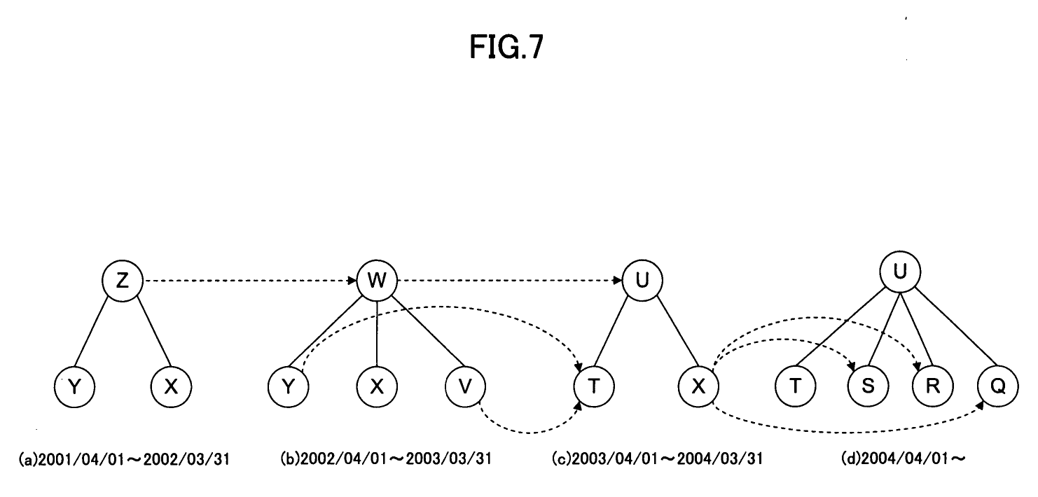

In FIG. 5, (a), (b), (c), and (d) contained in the group table 52 are illustrated for the purpose of facilitating an example of changes of the organization shown in FIG. 7, but (a), (b), (c), and (d) are not contained in the actual group table.

In the ID of the user table 51, the ID which identifies a user is stored. A user name is stored in the user name of the user table 51. The list of groups (list of IDs which identify the group to which the corresponding user belongs) is stored in the group list of the user table 51.

The ID which identifies a group is stored in the ID of the group table 52. A group name is stored in the group name of the group table 52. The start date of the term of validity of the group is stored in the start date of the group table 52. The end date of the term of validity of the group is stored in the end date of the group table 52. The group (parent group) of a high order with respect to the group is stored in the parent group of the group table 52.

In the document managerial system of this embodiment (or the user/group management service 15), the organization in a company is expressed by the groups divided in a hierarchical manner, and an executive is also expressed as a group, and the user/group management service 15 manages the user/group management database 16.

The user/group management service 15 may be configured to create a new group with the term of validity in the future beforehand, and register a time in the future as the start date and/or the end date of the term of validity of the new group into the document management system. It is possible to create a new group without stopping the document management system.

As shown in FIG. 5, the past group is also stored in the group table 52 and left unchanged therein. This means that a certain user belongs to the old group and the new group as shown in FIG. 5.

By comparing the present time with the start date and the end date of the group table 52, the user/group management service 15 (or document management system) can change all the groups at once from a certain time without causing a time lag.

FIG. 6 shows an example of the access control management database 14.

As shown in FIG. 6, the access control management database 14 contains the access control management table 53. The access control management table 53 includes as an item ID, a group name, and the list of groups which take over an access right.

The ID which identifies a group is stored in ID of access control management table 53. A group name is stored in a group name.

The list of groups (list of IDs which identify a group) with which the group stored in the group name taking over the access right is stored in the list of groups which take over the access right.

The access right (or ACL) of the document of a group with an old new group can be taken over without changing the access right (or ACL) of a document by having composition as shown in FIG. 6. For example, access control management service 13, when it belongs to a group with a certain user, it can be judged whether the access right of a document exists in the user (or group to which the user belongs) also including the information on a group that the group taking over the access right.

The access control management service 13 manages taking over of an access right.

As shown in FIG. 2 or FIG. 3, in a user/group management service 15, access control management service 13 exists independently, for example, cooperates with two or more user/group management services 15 with the network protocol of Web service.

As mentioned above, the access control management service 13 holds and manages the information on the taking-over relation between the groups of the access right (or ACL) to access control management database 14.

Hereafter, the concept of an example of changes of a group is shown in FIG. 7. FIG. 7 is a conceptual diagram showing an example of changes of a group. With reference to FIG. 5, FIG. 6, and FIG. 7, an example of the change of the group will be explained.

For example, suppose that group Z is taken over to group W and group V is newly established on 2002/04/01.

When the date of 2002/04/01 is reached, access control management service 13 adds ID “1” which identifies group Z to the list of group names which take over the access right of group W in access control management table 53.

Suppose that group W is taken over to group U and group Y and group V are taken over to group T on 2003/04/01.

When the date of 2003/04/01 is reached, access control management service 13 adds the ID “4” which identifies group W, and the ID “1” which identifies group Z which was taken over to group W, to the list of group names which take over the access right of group U in access control management table 53.

Moreover, on 2003/04/01, access control management service 13 adds the ID “2” which identifies group Y, and the ID “5” which identifies group V to the list of group names which take over the access right of group T in access control management table 53.

Suppose that group X is divided into group S, group R, and group Q on 2004/04/01.

When the date of 2004/04/01 is reached, access control management service 13 adds the ID “3” which identifies group X to the list of group names which take over the access rights of group S, group R and group Q in access control management table 53.

It is supposed that the user does not belong to the past group but belongs to the newest group at all times. For example, after the date of 2004/04/01, the user can belong only to any group of group U, group T, group S, group R, and group Q. The documents are held and managed in document-management database 12 together with the access rights (or ACL) to the past groups.

According to the above-described embodiment, it is possible to efficiently take measures to changes of the organization only by changing the list of groups which take over the access right of access control management table 53, without changing the access right (or ACL) of the documents for each of the change of the organization.

Since there are generally more document numbers held and managed in the organization far than the group number in an organization, compared with conventional technology, the device of this invention, a program, a recording medium, and the method are more efficient.

Since it is possible to create a group with the term of validity in the future in accordance with a change of the organization as shown in FIG. 5, a time lag up to the change of the access right (or ACL) of the document does not exist.

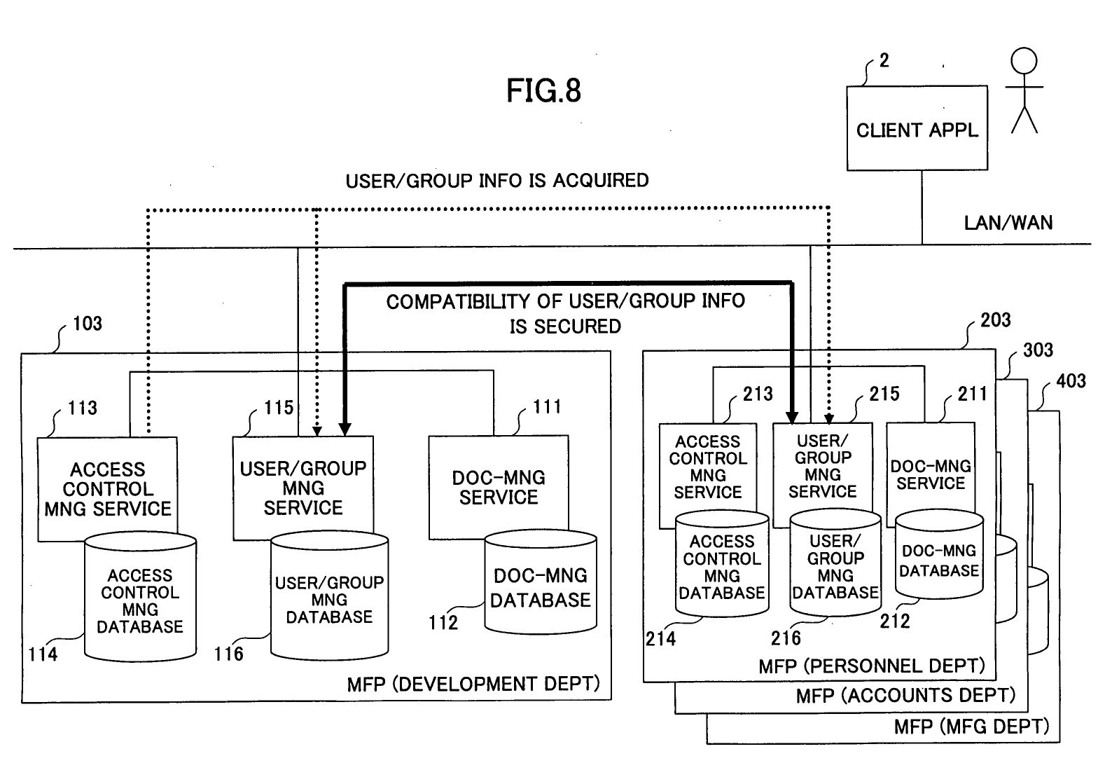

FIG. 8 shows the composition of an embodiment of the document management system when the image forming device (called MFP (multi-function peripheral)) 3 is used as an example of the document-management device 100.

As shown in FIG. 8, the document management system comprises the client application 2 which is installed in a PC, and the MFP 103 which are interconnected by LAN (local area network) or WAN (wide area network).

Each if the MFP 103 contains the document-management service 11, the document-management database 12, the access control management service 13, the access control management database 14, the user/group management service 15, and the user/group management database 16.

Each service and function of the database are the same as the function mentioned above. However, document-management service 11 mounted in the MFP 103 manages the document scanned in the MFP 103, and document-management database 12 mounted in the MFP 103 matches the scanned document and ACL (or access right) related to the document, and it manages and stores it.

In addition to the hardware composition which showed the hardware composition of MFP in FIG. 1, display input devices, such as an operation panel, the reading device which performs a scan, and the printer which performs a print are included.

Like the document-management program mentioned above, the MFP 103 is provided with the program (henceforth an MFP program) corresponding to each functional composition of the MFP 103 by recording medium 24, such as CD-ROM, or it is downloaded through a network, for example.

The recording medium 24 is set in drive device 23, and an MFP program is installed in HDD 29 via drive device 23 from recording medium 24. ROM 25 stores data or like

The RAM 26 reads and stores an MFP program from HDD 29 at the time of starting of the MFP 103, for example. The RAM 26 holds temporarily the data used for processing of an MFP program. The CPU 21 performs the processing according to the MFP program read and stored in RAM 26.

The HDD 29 stores the data stored in an MFP program, and the document scanned and read and the database mentioned above.

The user chooses and prints a document, when printing the document in the MFP 103 (for example, when it attests by logging in from the operation panel of the MFP 103, authentication is successful and authority exists).

The MFP 103 is managed for every section and the user belonging to a section is managed, for example in the user/group management service 15 of each MFP.

The user/group management service 15 of each MFP secure the compatibility of the information on a group that a user and its user belong.

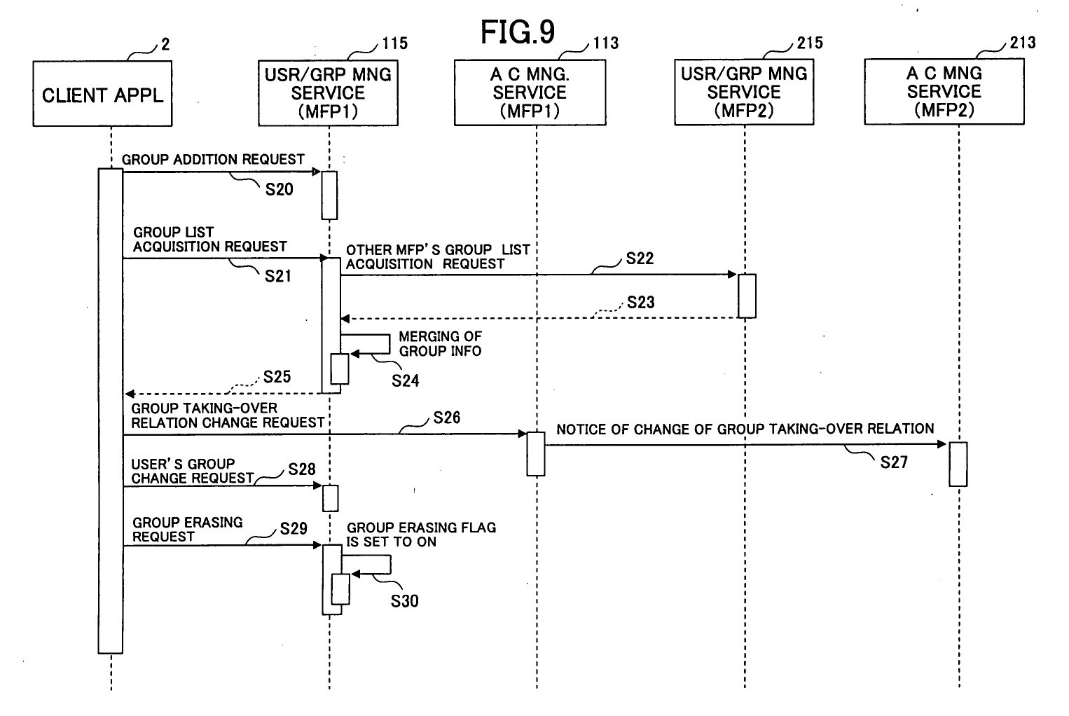

The method of security of compatibility will be explained using FIG. 9 through FIG. 12.

The access control management service 13 and the communication using the user/group management service 15, and SOAP of all the MFPs is accessed by carrying out, and the taking-over relation of the access right managed in access control management database 14 is managed including the user's information and group information of all the MFPs.

An example of the processing at the time of change of the organization in case the different user and different group for every MFP are managed hereafter is shown in FIG. 9.

FIG. 9 is a sequence diagram showing the processing at the time of change of the organization.

In FIG. 9 through FIG. 12, it is assumed that the MFPs connected by LAN or WAN are only two MFPs: MFP 103 and MFP 203, for the purpose of simplification of explanation.

For example, when adding a group, client application 2 transmits the addition request of the group to the user/group management service 115 of MFP 103 (step S20).

The user/group management service 115 stores the information on a new group in group table 52 as shown in FIG. 5, if the addition request of a group is received from client application 2.

When acquiring the list of the groups managed in a document management system, client application 2 transmits the list acquisition request of a group, for example to the user/group management service 115 of MFP 103 (step S21).

The user/group management service 115 will transmit the list acquisition request of a group to the user/group management service 215 of the other MFP (in the example of FIG. 9, the MFP 203), if the list acquisition request of a group is received from client application 2 (step S22).

When the list acquisition request of a group is received from a user/group management service 115, a user/group management service 215 will acquire the list of groups from group table 52 shown in FIG. 5, and will transmit to a user/group management service 115 (step S23).

The user/group management service 115 if the list of groups is acquired from a user/group management service 215. The list of groups is acquired from a user/group management database 161.

It merges with the list of the groups acquired from a user/group management service 115 in step S23 (step S24), and transmits to client application 2 of the group list of the merged result request-origin (step S25).

When changing the taking-over relation between groups, client application 2 transmits the registration (or change) request of the taking-over relation between groups, for example to access control management service 131 of MFP 103 (step S26).

When the registration (or change) request of the taking-over relation between groups is received from client application 2, the access control management service 131 registers a new group into the list of groups which take over the access right corresponding to the access control management table 53 as shown in FIG. 6, or changes the list of groups which take over the corresponding access right, and then transmits the notice of the registration or change to access control management service 132 (step S27).

When the registration (or change) request of the taking-over relation between groups is received from access control management service 131, the access control management service 132 registers a new group into or changes the list of groups which take over the access right corresponding to access control management table 53 as shown in FIG. 6.

For example, when changing a user's belonging group, client application 2 transmits a belonging group's change request to the user/group management service 115 of MFP 103 (step S28).

The user/group management service 115 will change the group list of user table 51 as shown in FIG. 5, if the belonging group's change request is received from client application 2.

For example, when deleting a group, client application 2 transmits the deletion request of the group to the user/group management service 115 of MFP 103 (step S29).

The user/group management service 115 will set ON to the item (not shown) which indicates the deletion flag of group table 52, if the deletion request of a group is received from client application 2 (step S30).

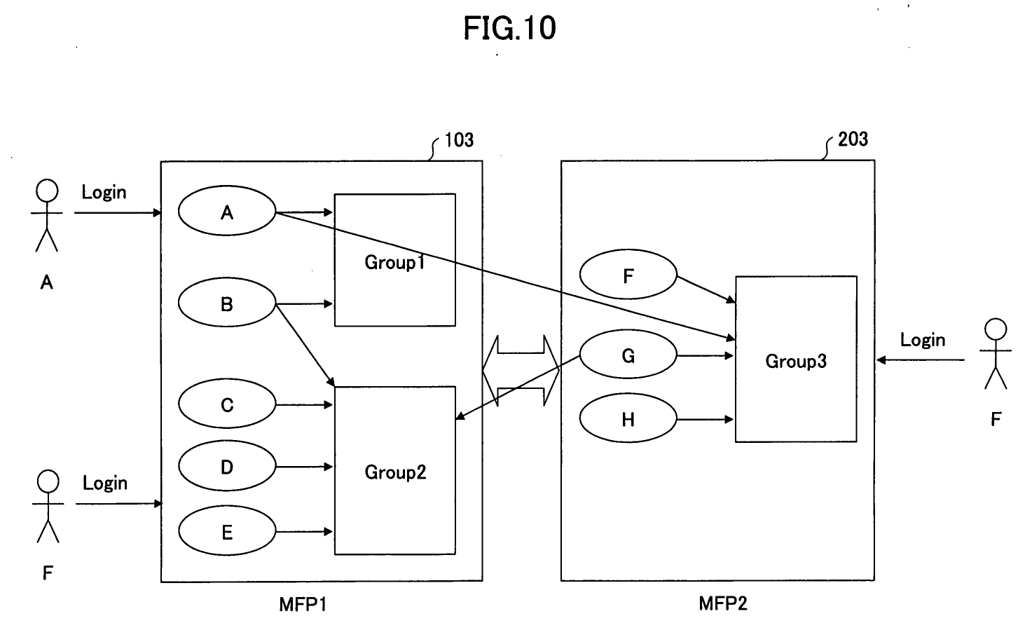

An example of the management model of user and group when the different user and the different group for every MFP are managed will be explained using FIG. 10. FIG. 10 is a diagram showing a user/group management model.

As shown in the example of FIG. 10, users A to E and groups 1 and 2 are managed in the MFP 103, and users F to H and group 3 are managed in the MFP 203.

In the MFP 103 and the MFP 203, the user/group management service 15 exchanges the user information and group information mutually, and all the users (users A to H) can log in to both the MFP 103 and the MFP 203.

In the MFP 103 and the MFP 203, the user/group management service 15 exchanges the user information and group information mutually, and all the users (users A to H) can belong to any group of the MFP 103 and the MFP 203.

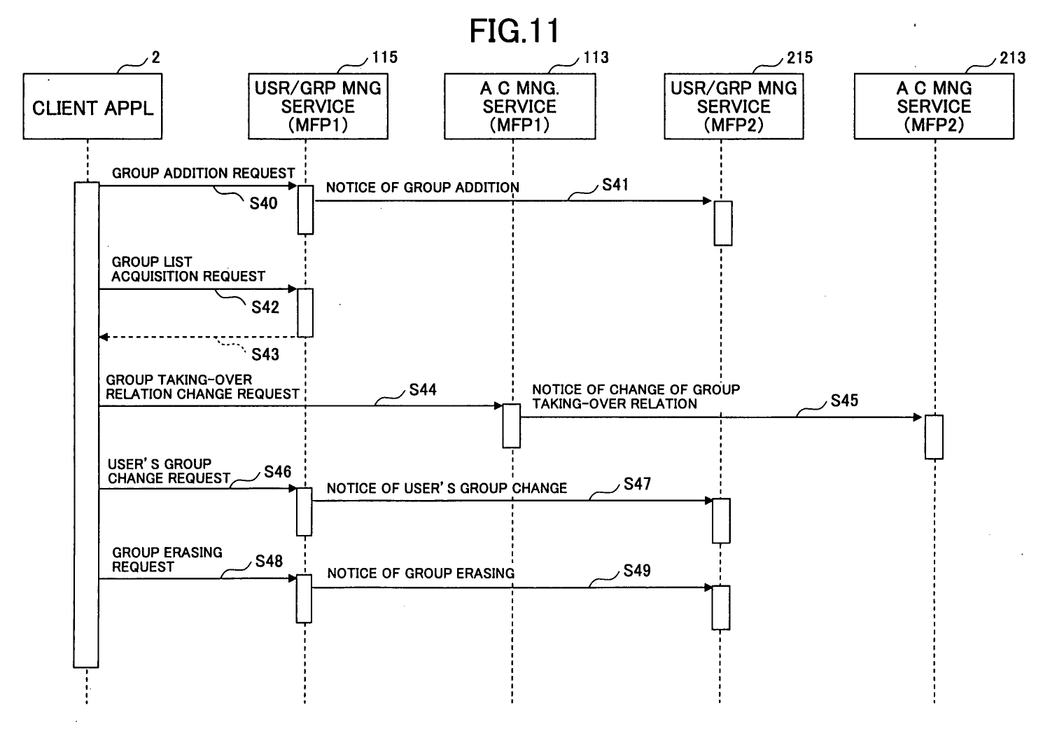

Next, an example of the processing at the time of change of the organization when the same user and the same group are managed for every MFP will be explained using FIG. 11.

FIG. 11 is a sequence diagram showing the processing at the time of change of the organization.

For example, when adding a group, client application 2 transmits the addition request of the group to the user/group management service 115 of MFP 103 (step S40).

If the addition request of the group is received from client application 2, user/group management service 115 stores the information on a new group is stored in group table 52 as shown in FIG. 5, and transmits the addition request of the group to user/group management service 215 (step S41).

The user/group management service 215 stores the information on a new group in group table 52 as shown in FIG. 5, if the addition request of a group is received from a user/group management service 115.

For example, when acquiring the list of the groups managed in the document management system, client application 2 transmits the group list acquisition request to the user/group management service 115 of MFP 103 (step S42).

If the list acquisition request of the group is received from client application 2, the user/group management service 115 acquires the list of groups from group table 52 shown in FIG. 5, and transmits the same to client application 2 (step S43) because the same user and the same group for every MFP are managed.

For example, when changing the taking-over relation between groups, client application 2 transmits the registration (or change) request of the taking-over relation between groups to access control management service 131 of MFP 103 (step S44).

If the registration (or change) request of the taking-over relation between groups is received from client application 2, the access control management service 131 registers a new group into the list of groups which take over the access right corresponding to the access control management table 53 as shown in FIG. 6, or changes the list of groups which take over the corresponding access right, and then transmits the notice of the registration or change to access control management service 132 (step S45).

If the registration (or change) request of the taking-over relation between groups is received from the access control management service 131, the access control management service 132 registers a new group into or changes the list of groups which take over the access right corresponding to the access control management table 53 as shown in FIG. 6.

In addition, when changing a user's belonging group, client application 2 transmits a belonging group's change request to the user/group management service 115 of MFP 103 (step S46).

If the belonging group's change request is received from client application 2, the user/group management service 115 changes the group list of the user table 51 as shown in FIG. 5, and transmits a belonging group's change request to the user/group management service 215 (step S47).

The user/group management service 215 will change the group list of user table 512 as shown in FIG. 5, if the belonging group's change request is received from the user/group management service 115.

For example, when deleting a group, client application 2 transmits the group deletion request of the group to the user/group management service 115 of MFP 103 (step S48).

If the group deletion request is received from client application 2, the user/group management service 115 sets ON to the item (not shown) which indicates the deletion flag of group table 52, and transmits the group deletion request to the user/group management service 215 (step S49).

The user/group management service 215 will set ON to the item (not shown) which indicates the deletion flag of group table 52, if the group deletion request is received from the user/group management service 115.

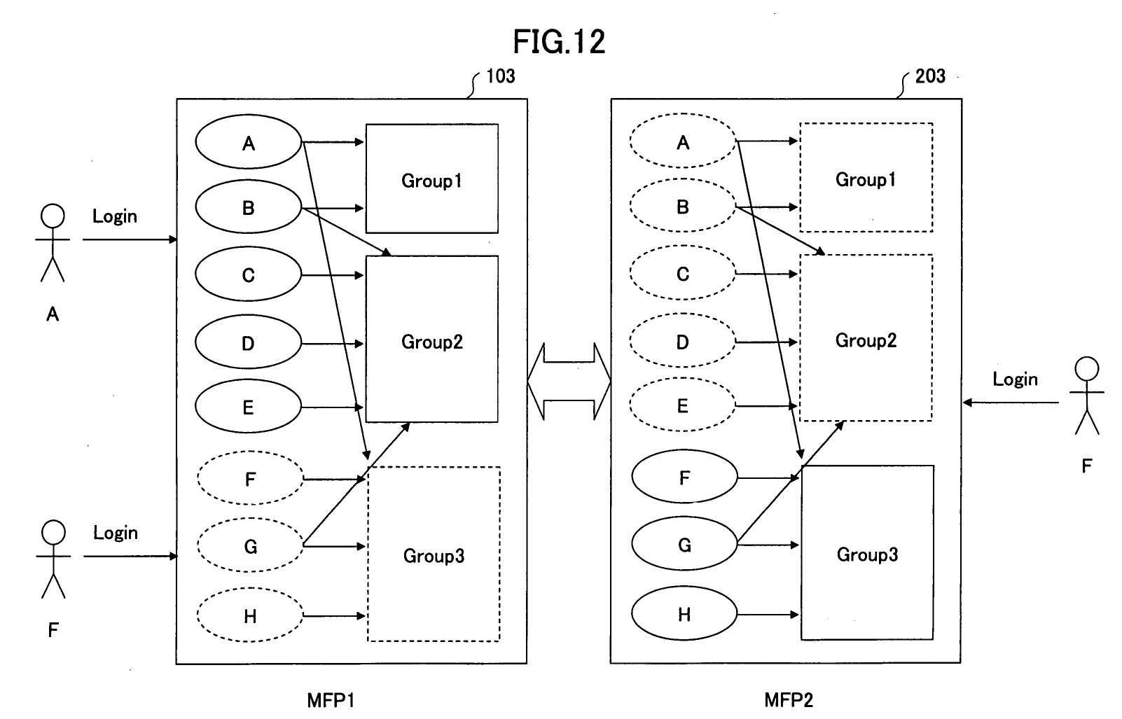

Next, another example of the management model of user and group when the same user and the same group are managed for every MFP will be explained using FIG. 12.

FIG. 12 is a diagram showing the user/group management model.

As shown in the example of FIG. 12, users A to E and groups 1 and 2 are managed in the MFP 103, and users F to H and group 3 are managed in the MFP 203.

In the MFP 103 and the MFP 203, each user/group management service 15 is synchronized mutually. The user information and the group information updated or added in each MFP are notified to all the MFPs, so that all the MFPs have a copy of the user information and the group information of the other MFPs.

Therefore, all the users (users A to H) are able to request a log in to both the MFP 103 and the MFP 203. All the users (users A to H) can belong to any group of the MFP 103 and the MFP 203.

As mentioned above, it is possible to efficiently take measures to changes of the organization by using the document-management device, the document-management program, the recording medium and the document-management method according to the present invention.

The document-management device in the claims corresponds to, for example, the document-management device 1 or the image forming device 3. The document-management unit in the claims corresponds to, for example, the document-management service 11. The access control management unit in the claims corresponds to, for example, the access control management service 13. The document storage unit in the claims corresponds to, for example, the document-management database 12 or HDD 29. The user/group management unit in the claims corresponds to, for example, the user/group management service 15. The taking-over relation storage unit in the claims corresponds to, for example, the access control management database 14 or HDD 29. The document in the foregoing description and in the claims means a document file (document data) or an image file (image data), for example.

The present invention is not limited to the above-described embodiments, and variations and modifications may be made without departing from the scope of the present invention.

Further, the present application is based on and claims the benefit of priority of Japanese patent application No. 2004-254571, filed on Sep. 1, 2004, and Japanese patent application No. 2005-224697, filed on Aug. 2, 2005, the entire contents of which are hereby incorporated by reference.

What is claimed is:

1. A document-management device comprising:
a document-management unit managing documents; and
an access control management unit managing information of a taking-over relation between groups of an access right of a document,
wherein the document-management unit acquires, in response to a document acquisition request from a client, both information of a currently valid group to which a user who has sent the document acquisition request belongs and information of a past group from which the currently valid group takes over an access right of the document, from the access control management unit, and the document-management unit determines whether information of group IDs of groups allowed to access the document is contained in the acquired information of the currently valid group and the past group.

2. The document-management device of claim 1 further comprising a document storage unit storing the document with a group list information of the group IDs of the groups allowed to access the document associated with the document, wherein the document-management unit acquires the group list information from the document storage unit, compares the acquired group list information with the acquired information of the currently valid group and the past group acquired from the access control management unit, and determines whether a part of the group list information is contained in the acquired information of the currently valid group and the past group.

3. The document-management device of claim 1 further comprising a user/group management unit managing user information of users and group information of groups to which the users belong, wherein the access control management unit acquires, in response to a request from the document-management unit, the information of the currently valid group to which the user related to the document acquisition request belongs, from the user/group management unit, and the access control management unit transmits to the document-management unit the acquired information of the currently valid group and the information of the past group from which the currently valid group takes over the access right of the document, the information of the past group being created from the taking-over relation between groups of the access right of the document.

4. The document-management device of claim 1 further comprising a taking-over relation storage unit which stores information related to the taking-over relation between groups of the access right of the document

5. The document-management device of claim 3 wherein the user/group management unit provides and manages a term of validity of a group.

6. The document-management device of claim 5 wherein the term of validity managed by the user/group management unit is set up with a future date.

7. The document-management device of claim 5 wherein the term of validity comprises a start date and an end date.

8. The document-management device of claim 3 wherein the document-management device is connected to one or more document-management devices having the same composition via a network, and a compatibility of the user information and the group information of the user/group management unit of each document-management device is secured.

9. The document-management device of claim 8 wherein the user/group management units of the document-management devices manage information of users and groups which are different for every document-management device.

10. The document-management device of claim 8 wherein the user/group management units of the document-management devices manage information of users and groups which are the same for every document-management device.

11. A computer program product embodied therein for causing a computer to execute a document-management method, the computer acting as a document-management device including a document-management unit managing documents, and an access control management unit managing information of a taking-over relation between groups of an access right of a document, the document-management method comprising:
acquiring, in response to a document acquisition request from a client, both information of a currently valid group to which a user who has sent the document acquisition request belongs and information of a past group from which the currently valid group takes over an access right of the document, from the access control management unit; and
determining whether information of group IDs of groups allowed to access the document is contained in the acquired information of the currently valid group and the past group.

12. The computer program product of claim 11 wherein the document-management device further includes a document storage unit storing the document with a group list information of the group IDs of the groups allowed to access the document associated with the document, the document-management method comprising:
acquiring the group list information from the document storage unit;
comparing the acquired group list information with the acquired information of the currently valid group and the past group acquired from the access control management unit; and
determining whether a part of the group list information is contained in the acquired information of the currently valid group and the past group.

13. The computer program product of claim 11 wherein the document-management device further includes a user/group management unit managing user information of users and group information of groups to which the users belong, the document-management method comprising:
causing the access control management unit to acquire, in response to a request from the document-management unit, the information of the currently valid group to which the user related to the document acquisition request belongs, from the user/group management unit; and
causing the access control management unit to transmit to the document-management unit the acquired information of the currently valid group and the information of the past group from which the currently valid group takes over the access right of the document, the information of the past group being created from the taking-over relation between groups of the access right of the document.

14. The computer program product of claim 13 wherein the user/group management unit provides and manages a term of validity of a group.

15. The computer program product of claim 14 wherein the term of validity managed by the user/group management unit is set up with a future date.

16. The computer program product of claim 14 wherein the term of validity comprises a start date and an end date.

17. The computer program product of claim 13 wherein the computer acting as the document-management device is connected to one or more computers acting as one or more document-management devices having the same composition via a network, and a compatibility of the user information and the group information of the user/group management unit of each document-management device is secured.

18. The computer program product of claim 17 wherein the user/group management units of the document-management devices manage information of users and groups which are different for every document-management device.

19. The computer program product of claim 17 wherein the user/group management units of the document-management devices manage information of users and groups which are the same for every document-management device.

20. A computer-readable recording medium embodied therein for causing a computer to execute a document-management method, the computer acting as a document-management device including a document-management unit managing documents, and an access control management unit managing information of a taking-over relation between groups of an access right of a document, the document-management method comprising:
acquiring, in response to a document acquisition request from a client, both information of a currently valid group to which a user who has sent the document acquisition request belongs and information of a past group from which the currently valid group takes over an access right of the document, from the access control management unit; and
determining whether information of group IDs of groups allowed to access the document is contained in the acquired information of the currently valid group and the past group.

21. A document-management method for use in a document-management device including a document-management unit managing documents, and an access control management unit managing information of a taking-over relation between groups of an access right of a document, the document-management method comprising:
acquiring, in response to a document acquisition request from a client, both information of a currently valid group to which a user who has sent the document acquisition request belongs and information of a past group from which the currently valid group takes over an access right of the document, from the access control management unit; and
determining whether information of group IDs of groups allowed to access the document is contained in the acquired information of the currently valid group and the past group.
